(19) United States
(12) Patent Application Publication
(10) Pub. No.: US 2012/0236997 A1
(43) Pub. Date: Sep. 20, 2012

(54) ALLOY COMPRISING TWO REFRACTORY METALS, PARTICULARLY W AND TA AND X-RAY ANODE COMPRISING SUCH ALLOY AND METHOD FOR PRODUCING SAME

(75) Inventors: Paul Xu, Oswego, IL (US); Kevin Kraft, Plainfield, IL (US); Min He, Downers Grove, IL (US); Gerald James Carlson, Aurora, IL (US)

(73) Assignee: KONINKLIJKE PHILIPS ELECTRONICS N.V., EINDHOVEN (NL)

(21) Appl. No.: 13/512,977

(22) PCT Filed: Nov. 30, 2010
(86) PCT No.: PCT/IB2010/055489

§ 371 Date: May 31, 2012

Related U.S. Application Data
(60) Provisional application No. 61/267,178, filed on Dec. 7, 2009.

(51) Int. Cl. C22C 27/04; H01J 35/08; B05D 5/12; C22C 1/02; B22F 9/16

(52) U.S. Cl. 378/143; 75/10.13; 75/338; 75/331; 427/123; 420/430

(57) ABSTRACT

An alloy comprising at least two refractory metals and a method for forming such alloy are proposed. In the alloy, a first refractory metal such as tantalum forming a minor portion of the alloy is completely dissolved in a second refractory metal such as tungsten forming a major portion of the alloy. The alloy may be formed by providing the two refractory metals in a common crucible (step S1), melting both refractory metals by application of an electron beam (step S2), mixing the molten refractory metals (step S3) and solidifying the melt (step S4). Due to the possible complete mixing of the refractory metal components in a molten state, improved material properties of the solidified alloy may be achieved. Furthermore, due to the use of tantalum instead of rhenium together with tungsten, a cheap and resistant refractory metal alloy may be produced, which alloy may be used for example for forming a focal track region of an X-ray anode.

### FIELD OF THE INVENTION

The present invention relates to an alloy comprising at least two refractory metals and to an X-ray anode comprising such alloy. Furthermore, the present invention relates to a method of preparing such alloy and to a method of preparing such X-ray anode.

### BACKGROUND OF THE INVENTION

Conventional rotating anode X-ray tubes are usually provided with an X-ray anode made up with a refractory metal target. Such a target should have many favorable properties including high temperature resistance, high mechanical strength, and good thermal conductivity and high heat capacity. Rotating anodes in X-ray devices are subjected to large mechanical stresses, as well as thermal-mechanical stresses induced from an X-ray generation process. X-Rays are generated by electron bombardment of the anode's focal track. A vast majority of energy applied to the focal spot and subsequent anode surface is transformed into heat, which must be managed. The localized heating of the focal spot, due to the electron bombardment, may be a function of the target angle, focal track diameter, focal spot size (length×width), rotating frequency, power applied, and material properties such as thermal conductivity, density, and specific heat. Focal spot temperatures and thermal-mechanical stresses are usually managed by adequately controlling and selecting the above mentioned variables.

However, in many cases, the X-ray tube protocols may be limited due to a limited ability to modify these variables because of material property limitations. Thus, a conventional rotating anode X-ray tube is often limited by the mechanical properties of the anode's substrate material, as well as the ability of the material to remove the heat from a localized volume.

Conventionally, X-ray anodes are manufactured with a Tungsten-Rhenium alloy by various means. The current methods may be either mechanically mixing Tungsten and Rhenium powder or use of solvents containing Rhenium to mix with Tungsten powder. Both current practices then rely on Rhenium diffusion during a sinter fire process to create the Tungsten-Rhenium alloy. Rhenium is added to the Tungsten focal track to create an alloy with improved ductility.

However, the current alloy manufacturing processes may have a potential of creating a poor distribution of elements affecting the material properties.

### SUMMARY OF THE INVENTION

There may be a need for an alloy comprising at least two refractory metals wherein the alloy has improved material properties. Furthermore, there may be a need for a method of forming such alloy. In addition, there may be a need for an X-ray anode in which at least a focal track region comprises such alloy and for a method of preparing such X-ray anode.

These needs may be met by the subject-matter of the independent claims. Advantageous embodiments of the invention are given in the dependent claims.

According to a first aspect of the present invention, a method for forming an alloy comprising at least two refractory metals is proposed. The method comprises the following steps preferably in the indicated order: (a) providing the two refractory metals in a common crucible; (b) melting both refractory metals by application of an electron beam; (c) mixing the molten refractory metals; and (d) solidifying the melt.

According to a second aspect of the present invention, a method for preparing an X-ray anode is proposed wherein the method comprises preparing an alloy using the method according to the above first aspect of the present invention and applying the alloy at least to portions of an X-ray anode substrate which portions form a focal track region of the X-ray anode.

According to a third aspect of the present invention, an alloy comprising at least two refractory metals is proposed. In such alloy, a first refractory metal forming a minor portion of the alloy is completely dissolved in a second refractory metal forming a major portion of the alloy.

According to a fourth aspect of the present invention, an X-ray anode is proposed wherein at least a portion of the X-ray anode forming a focal track region comprises the alloy according to the above third aspect of the present invention.

A gist of the present invention may be seen as based on the following findings and ideas:

It has been observed that in present refractory metal alloys material properties are frequently non-optimum. Such deficiency in material properties may be attributed to a poor distribution of the elements forming the alloy, i.e. the particles from which the alloy is composed. Conventionally the alloy-forming refractory metals are provided in the form of a powder wherein the mixture of powders of the pure metal is compacted, heated using for example electric current and further fabricated by e.g. cold working with annealing steps. Using such conventional fabrication methods, refractory metal alloys may be worked into wires, ingots, rebars, sheets or foils. However, due to the provision of the alloy components in the form of a powder comprising macroscopic particles, the atoms of the at least two refractory metals are usually not homogeneously distributed throughout a final alloy.

An idea is now to provide the at least two refractory metals in a common crucible and to melt both refractory metals such that the molten refractory metals can easily and preferably completely mix. Therein, it has been observed that an advantageous way of melting refractory metals typically having very elevated melting point temperatures may be electron beam heating, i.e. directing an electron beam comprising high energy electrons onto the refractory metal material comprised in the crucible. By application of an electron beam, very high temperatures well above the melting point of refractory metals may be achieved. After the molten refractory metals have mixed, the melt may be cooled down thereby re-solidifying the melt. The solidified melt then forms an alloy in which the two refractory metals are completely dissolved into each other. Such homogeneous mixture of alloy components may result in advantageous material properties of the prepared alloy such as high temperature resistance, high mechanical strength, good thermal conductivity, high thermal capacity, etc.

Refractory metals are a class of metals that are extraordinarily resistant to heat and wear. A definition which elements belong to this group may, in a wider interpretation, comprise 10 elements of the group 4, group 5 group 6 excluding the transuranium element but including the group 7 element rhenium. In a narrower definition, the group of refractory metals at least comprises the five metals tungsten, molybdenum, niobium, tantalum and rhenium.

According to an embodiment of the present invention, the two refractory metals comprised in the prepared alloy are tungsten (W) and tantalum (Ta). Therein, tantalum may be provided in a weight percentage of between 5% and 15%, preferably between 8% and 12%, for example approximately 10% referred to the entire alloy weight. The remainder of the alloy may be tungsten or may be tungsten further comprising other elements, particularly other refractory metal elements.

While conventional refractory metal alloys used for example for X-ray anodes are generally composed from tungsten (W) and rhenium (Re) in order to obtain sufficient thermal and mechanical strength, it has been observed that particularly rhenium may be extremely expensive resulting in a high price of the alloy and devices fabricated therewith. Furthermore, it has been observed that the rhenium comprised in the alloy may be responsible for some focal track erosion problems frequently occurring during X-ray anode operation. Such focal track erosion problems are also known as “mudflatting”.

It has now been an idea to replace the rhenium component comprised in conventional refractory metal alloys such as specifically tungsten-based alloys by a tantalum component. Tantalum is much cheaper than rhenium and surpasses most other refractory metals in ductility. Tantalum is dark, dense, ductile, very hard, easily fabricated and highly conductive of heat and electricity. Furthermore, the metal is renowned for its resistance to corrosion.

Furthermore, it has been observed that using tantalum instead of rhenium in an alloy together with tungsten, focal track erosion problems (mudflatting) may be alleviated. A reasonable explanation of this observation may be that mudflatting starts from a loss of molecules during e.g. operation of an X-ray anode using the refractory metal alloy. During such anode operation, particles with high momentum hit the surface of the anodes focal track. It has been found that a sputter rate of rhenium may be 470 Angstroms per minute (470 Å/min) while sputtering with argon (Ar) having an energy of 500 eV at a flux of 1 mA/cm². Tungsten and tantalum may have a significantly lower sputter rate of about 340 and 380 Å/min, respectively. Accordingly, by replacing rhenium by tantalum in an alloy together with tungsten, the overall sputter rate of the alloy may be significantly reduced thereby possibly alleviating the focal track erosion problem (mudflatting).

According to a further embodiment of the present invention, at least one of the refractory metals comprised in the alloy is provided as a powder. Preferably, both refractory metal components are provided in the form of a powder. The powder may comprise particles having for example a size in the range of 2 μm to 100 μm. By providing the refractory metal(s) as a powder, the two refractory metals may be already pre-mixed to a certain degree before melting. Accordingly, as a mixing process within the subsequently molten refractory metals may comprise diffusion and convection mechanisms, a complete mixing of the alloy components resulting in a complete dissolution of the two refractory metal components into each other may be achieved the faster the more the alloy forming components are already pre-mixed before the melting process. Accordingly, providing the refractory metal components in the form of small particles forming a powder may significantly accelerate the mixing process of the molten refractory metals and may therefore significantly shorten the overall duration needed for performing the proposed method.

According to a further embodiment of the present invention, the molten refractory metals are quenched for solidification. Therein, “quenching” may mean that the melt including the two molten refractory metals is cooled-down very rapidly. For example, cooling rates in a range of 200 Ks⁻¹ to 2000 Ks⁻¹, e.g. between 800 Ks⁻¹ and 1200 Ks⁻¹ may be applied. For example, the melt may be rapidly cooled-down by bringing it into contact with a very cool liquid such as liquid nitrogen.

One possible way of rapidly cooling the melt comprising the molten refractory metals may be a pulverization process by gas atomization thereby solidifying the melt. Therein, the liquid melt is formed to a powder for a fine particle distribution. Typically, a gas atomization process is carried out by pouring melted metal through a refractory orifice, a high pressure inert gas, typically argon, breaks up the melted metal into liquid droplets, which are solidified.

Using a quenching process, i.e. a rapid cool-down, for solidifying the melt comprising the two refractory metals may advantageously result in forming a so-called “infinite solid solution”.

A solid solution may be a solid-state solution of one or more solutes in a solvent. Therein, a solute may be interpreted as the component forming a minor part of the final product, i.e. the final alloy, whereas the solvent may be interpreted to be formed by the major component of the final product. In the present example, the solute may be e.g. tantalum, whereas the solvent may be tungsten. A mixture comprising a solute and a solvent is considered a solution rather than a compound when a crystal structure of the solvent remains unchanged by addition of the solutes and when a mixture remains in a single homogeneous phase. This often happens when the two components, i.e. in the present case the two refractory metals, involved are close together on the periodic table. The solute may incorporate into the solvent crystal lattice substitutionally, i.e. by replacing a solvent particle in the lattice, or interstitial, i.e. by fitting into a space between solvent particles. Both of these types of solid solution may affect the properties of the material by distorting the crystal lattice and disrupting physical and electrical homogeneity of the solvent material. Solid solutions may have important commercial and industrial applications as such mixtures often have superior properties to pure materials. Even small amounts of solute may affect electrical and physical properties of the solvent.

The term “infinite” in “infinite solid solution” may be interpreted in that the two metals can form a solid solution at any percentage and may still maintain a single phase, i.e. the percentage of solute can be from 0 to 100% without generating a second phase.

It is to be noted that aspects and embodiments of the present invention have been described with reference to different subject-matters. In particular, some embodiments have been described with reference to the method type claims whereas other embodiments have been described with reference to product type claims. However, a person skilled in the art will gather from the above and the following description that, unless other specified, in addition to any combination of features belonging to one type of subject-matter also any combination between features relating to different subject-matters is considered to be disclosed with this application.

### BRIEF DESCRIPTION OF THE DRAWINGS

Features and advantages of the present invention will be further described with respect to specific embodiments as shown in the accompanying figures but to which the invention shall not be limited.

FIG. 1 shows a flow-chart indicating steps of a method for forming an alloy according to an embodiment of the present invention.

FIG. 2 illustrates an arrangement for melting refractory metals using an electron beam in accordance with an embodiment of the present invention.

FIG. 3 shows an X-ray anode comprising an alloy according to an embodiment of the present invention.

Features shown in the drawings are schematic only and not to scale.

### DETAILED DESCRIPTION OF EMBODIMENTS

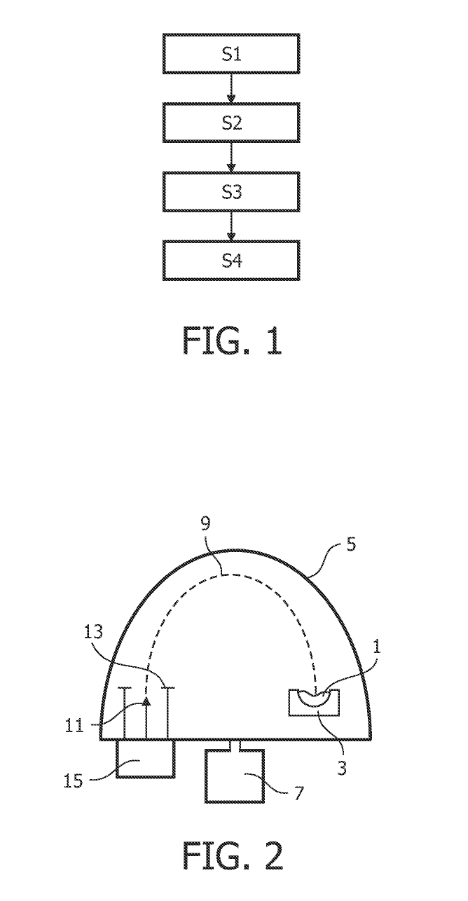

Referring to FIGS. 1 and 2, a method for forming an alloy comprising two refractory metals according to an embodiment of the present invention will be described.

As indicated in the flow-chart shown in FIG. 1, in a first step (step S1) two refractory metals such as tungsten (W) and tantalum (Ta) are provided in a form of small particles forming a powder. As shown in FIG. 2, the powder 1 comprising the two refractory metal components is filled into a crucible 3 enclosed within a vacuum container 5.

Next, a vacuum of a pressure of for example 10⁻⁵ torr may be generated within the vacuum container 5 using a vacuum pump 7. Then, in a next step (S2), a high energy electron beam 9 is directed onto the pulverized mixture of refractory metals comprised in the crucible 3. The electron beam 9 is emitted by a cathode 11 and is accelerated and controlled by an anode 13, the cathode 11 and the anode 13 being connected to a control 15. The electrons emitted by the cathode 11 are accelerated using the anode 13 to very high energies in the range of between 20 keV and 50 keV. Furthermore, the anode 13 may be controlled such as to focus the electron beam 9 onto the refractory metals comprised in the crucible 3 such that the electron beam 9 may be scanned along a surface of the refractory metal powder 1 in order to homogeneously heat the powder within the crucible 3. Upon impact of the high energy electrons of the electron beam 9, the refractory metal powder 1 is heated to such high temperatures of for example above 3410° C. being the melting point of tungsten such that a melt comprising both refractory metals in a molten liquid state is formed. In this molten state, the two refractory metals may mix (step S3) due to diffusion and/or convection processes. Thereby, a mixture in which the tantalum is completely dissolved within the tungsten may be generated.

In a final step (step S4), the melt comprised in the crucible 3 is rapidly cooled (“quenched”) thereby solidifying the melt. Such cool-down process may be realized by gas atomization of the liquid melt. Therein, the molten refractory metal mixture may be forced through an orifice and gas may be introduced into the metal stream just before it leaves a nozzle, serving to create turbulence as the entrained gas expands due to heating and exits into a large collection volume exterior to the orifice. The collection volume is filled with gas to promote further turbulence of the molten metal jet. The generated powder stream may be segregated using gravity.

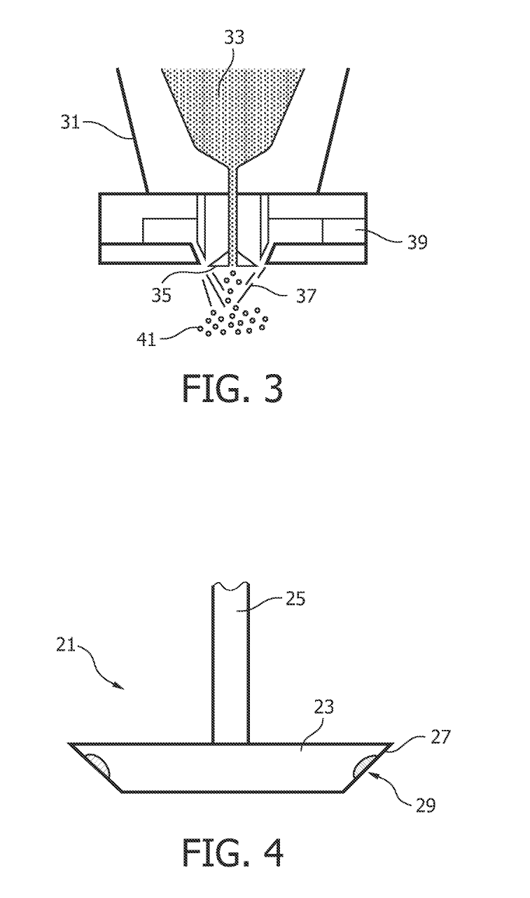

In FIG. 3, a typical gas atomization nozzle 31 is shown. Such nozzle 31 may be connected to the crucible 3 but has not been shown in FIG. 2 for clarity reasons. A liquid melt 33 coming from a tundish or crucible may flow to a nozzle orifice 35 where it may be ejected. A gas jet 37 coming from a gas inlet 39 is directed onto the ejected metal stream in order to create a turbulence to thereby atomize the metal stream into metal droplets 41 which may be rapidly cooled.

FIG. 4 shows a cross-section of an X-ray anode 21 according to an embodiment of the present invention. The X-ray anode 21 comprises a disk-shaped substrate 23 attached to a shaft 25 around which the anode may be rotated during operation. On a slanted surface 27, a focal track region 29 is provided. This focal track region 29 comprises the tungsten-tantalum-alloy the preparation of which has been described above. For applying the alloy, mainly two methods may be used. One method is powder metallurgy, in which tungsten alloy powder is first put in a mould. It is distributed at the position of focal track. Then, TZM being a Molybdenum alloy with 0.5 wt. % Ti and 0.07 wt % Zr, which has better properties than pure molybdenum or other substrate metal powder, such as Mo—La₂O₃ powder, is added into the mould. Powders are pressed to a blank of target by isostatic press. The other method is first using powder metallurgy to make a TZM substrate, then vacuum plasma spraying tungsten alloy on TZM substrate.

Due to the improved material properties of this tungsten-tantalum-alloy, the X-ray anode 21 may have superior characteristics such as an improved thermal resistance, improved mechanical strength, etc. Furthermore, such X-ray anode 21 may be produced at reduced costs as the expensive rhenium conventionally comprised in the focal track material of prior art X-ray anodes has been replaced by comparatively cheap tantalum. The proposed targets may be used in rotating anode X-ray tubes as for example envisioned as high performance products that could be used in cardio-vascular or CT medical imaging equipment. X-ray tubes used for inspection and security could also benefit therefrom.

It should be noted that the term “comprising” does not exclude other elements or steps and that the indefinite article “a” or “an” does not exclude the plural. Also elements described in association with different embodiments may be combined. It should also be noted that reference signs in the claims shall not be construed as limiting the scope of the claims.

### List of Reference Signs:

1 Powder comprising two refractory metals

3 Crucible

5 Vacuum container

7 Vacuum pump

9 Electron beam

11 Cathode

13 Anode

15 Control

21 X-ray anode

23 Substrate

25 Shaft

27 Slanted surface

29 Focal track

31 gas atomization nozzle

33 melt

35 nozzle orifice

37 gas jet

39 gas inlet

41 metal droplets

1. A method for forming an alloy comprising at least two refractory metals, the method comprising:
providing the two refractory metals in a common crucible (3);
melting both refractory metals by application of an electron beam (9);
mixing the molten refractory metals;
solidifying the melt.

2. The method of claim 1, wherein a first refractory metal is tungsten and a second refractory metal is tantalum.

3. The method of claim 2, wherein tantalum is provided in a weight percentage of between 5 and 15%.

4. The method of claim 1, wherein at least one of the refractory metals is provided as a powder (1).

5. The method of claim 1, wherein the molten refractory metals are quenched for solidification.

6. The method of claim 1, wherein the molten refractory metals are pulverized by gas atomization for solidification.

7. A method of preparing an X-ray anode (21), the method comprising: preparing an alloy using the method according to claim 1; applying the alloy at least to portions of an X-ray anode substrate which portions form a focal track region (29) of the X-ray anode (21).

8. An alloy comprising at least two refractory metals, wherein a first refractory metal forming a minor portion of the alloy is completely dissolved in a second refractory metal forming a major portion of the alloy.

9. The alloy of claim 8, wherein the first refractory metal is tantalum and the second refractory metal is tungsten.

10. The alloy of claim 9, wherein tantalum is comprised in the alloy in a weight percentage of between 5% and 15%.

11. The alloy of claim 8, wherein the alloy is provided as a powder.

12. The alloy of claim 8, wherein the first and second refractory metals form a solid solution.

13. An X-ray anode (21), wherein at least a portion of the X-ray anode forming a focal track region comprises the alloy according to claim 8.
